(19) United States
(12) Patent Application Publication
(10) Pub. No.: US 2014/0110934 A1
(43) Pub. Date: Apr. 24, 2014

(54) FLUID-TIGHT FLEXURAL JOINT

(71) Applicant: Airgo IP, LLC, Edmond, OK (US)

(72) Inventors: Kyle J. Berkness, Savage, MN (US); Phillip K. Berkness, Savage, MN (US)

(73) Assignee: Airgo IP, LLC, Edmond, OK (US)

(21) Appl. No.: 14/057,927

(22) Filed: Oct. 18, 2013

Related U.S. Application Data
(60) Provisional application No. 61/717,077, filed on Oct. 22, 2012.

(51) Int. Cl. F16L 21/02

(52) U.S. Cl. CPC F16L 21/02
USPC 285/231

(57) ABSTRACT

A fluid-tight flexural joint for enabling a first portion of a rigid fluid flow conduit to flex with respect to a second portion thereof to accommodate off-axis conduit connections. The joint includes a knuckle adjacent to one end of a first conduit portion and defining a fluid flow channel extending therethrough in axial alignment and fluid communication with the first conduit portion. A knuckle housing threadably engages an end portion of a second conduit portion and is in fluid communication with the second conduit portion and disposed about and in sealing engagement with the knuckle so as to define a continuous fluid passageway extending through the first and second conduit portions and the knuckle whereby the first and second conduit portions are coupled together in a flexible fluid-tight sealing engagement and the first portion of the conduit can flex with respect to the second portion thereof.

### BACKGROUND OF THE INVENTION

The present invention relates to a fluid-tight flexural joint particularly adapted for use in a rigid conduit that allows a first portion of the conduit to flex with respect to a second portion thereof. In certain fluid flow applications, it is preferable and often necessary to form a fluid flow conduit of a rigid material. Leakage problems can arise, however, if a rigid conduit needs to be fluid-tight and is off-center in that its extended ends are not in axial alignment with their respective connections. This misalignment problem is particularly acute in applications in which there is relative rotational movement between the conduit and at least one of its connections. For example, in many automatic tire inflation systems the outer diameter of at least one of the conduit's extended ends is in sealing engagement with a surrounding flexible seal and relative movement occurs between the seal and the conduit. If the hub cap which carries the rotary union housing is out of axial alignment with the axle spindle, a rigid conduit extending therebetween will incur relatively rapid wear as will the surrounding seal, resulting in an air leak. Accordingly, conduits constructed of a flexible material, such as nylon, have been proposed to accommodate the misalignment. However, the outer surface of the flexible conduit abutting the surrounding seal is subjected to temperature fluctuations during use as a result of the relative movement therebetween, resulting in cold flow about the outer diameter of the flexible conduit, shrinking the outer conduit surface adjacent the seal and curtailing the useful life of the conduit. To avoid cold flow issues, conduits were developed in which the portion of the conduit subjected to the relative rotation with the surrounding seal was constructed of metal and the remainder of the conduit is constructed of flexible material such as nylon with the two portions being joined by a ferrule. The ferrule, however, proved to be a weak point in such systems. In other tire inflation systems, the downstream ends of the conduits have been provided with a flared or radiused flange, a mating curvilinear bearing and a surrounding lip seal in an effort to allow for the relative rotation of the conduit and seals and reduce wear. However, the relative rotation between the lip seal and a misaligned conduit on such systems again has been found to create wear on the seal, leading to leakage and curtailing the life of the system. Accordingly, it would be highly desirable if a fluid-tight joint could be developed for such rigid conduits that would allow a first portion of the conduit to flex relative to a second portion and thus accommodate any misalignment. The flexural joints of the present invention obtain such a result.

### SUMMARY OF THE INVENTION

In accordance with preferred embodiments, a fluid-tight flexural joint is provided that enables a first portion of a rigid fluid flow conduit to flex with respect to a second portion thereof to accommodate off-axis conduit connections. In one embodiment of the present invention, the joint preferably includes a hollow threaded nipple projecting from one end of the first conduit portion and terminating in a sealing surface that is disposed about a first fluid flow opening. A knuckle housing projects from one end of the second conduit portion and a cylindrical knuckle having a transverse opening extending therethrough is rotatably disposed in the knuckle housing such that the transverse opening in the knuckle is in axial alignment with the knuckle housing and the aforesaid first fluid flow opening in the nipple. The nipple on the first conduit portion projects through and threadably engages the transverse opening in the knuckle so as to be moveable with the knuckle in the knuckle housing while defining a continuous fluid passageway extending through said first and second conduit portions, the nipple and the knuckle. An annular flexible seal is disposed between an annular shoulder formed in the knuckle housing and the sealing surface of the nipple forming an airtight seal between the first and said second conduit portions. A chemical or mechanical connection, such as solder or a set screw, is disposed between the knuckle and the nipple to lock the nipple to the knuckle within the housing and axially space the first conduit portion a predetermined distance from the knuckle housing whereby the first and second conduit portions are coupled together in a flexible sealing engagement.

In a second embodiment, the flexural joint preferably includes a spherical knuckle projecting from one end of a first conduit portion. The knuckle defines a channel extending therethrough axially aligned with and in fluid communication with the first conduit portion. A cap projects from one end of a second conduit portion and cooperates therewith to define a knuckle housing disposed about and in sealing engagement with the generally spherical knuckle on the first conduit portion such that the knuckle is moveable within and with respect to the knuckle housing while defining a continuous fluid passageway extending through the first and second conduit portions and the knuckle whereby the first and second conduit portions are again coupled together in a flexible sealing engagement.

### BRIEF DESCRIPTION OF THE DRAWINGS

FIG. 1 is a side view of a conduit containing the fluid-tight flexural joint of the present invention.

FIG. 2 is a sectional view taken along the line 2-2 of FIG. 1.

FIG. 3 is an exploded view of the conduit portions and flexural joint of FIGS. 1 and 2.

FIG. 4A is a side view of a conduit containing the fluid-tight flexural joint of the present invention of FIGS. 1-3 illustrating the flexing therein and showing the interior surfaces thereof in dashed lines.

FIG. 4B is a side view of the conduit containing the fluid-tight flexural joint of the present invention shown in FIG. 4A but wherein the conduit and flexural joint are rotated 90° with respect to the orientation illustrated in FIG. 4A.

FIG. 5 is a sectional side view of a conduit containing a second embodiment of the fluid-tight flexural joint of the present invention.

FIG. 6 is an exploded sectional view of the conduit portions and the flexural joint of FIG. 5.

FIG. 7 is an exploded view of the conduit portions and a modified form of the second embodiment of the present invention.

FIG. 8 is a sectional side view of the conduit and the modified form of the present invention of FIG. 7.

FIG. 9 is a sectional side view of the conduit and the modified form of the present invention of FIGS. 7 and 8 showing the flexing thereof.

### DETAILED DESCRIPTION OF THE PREFERRED EMBODIMENTS

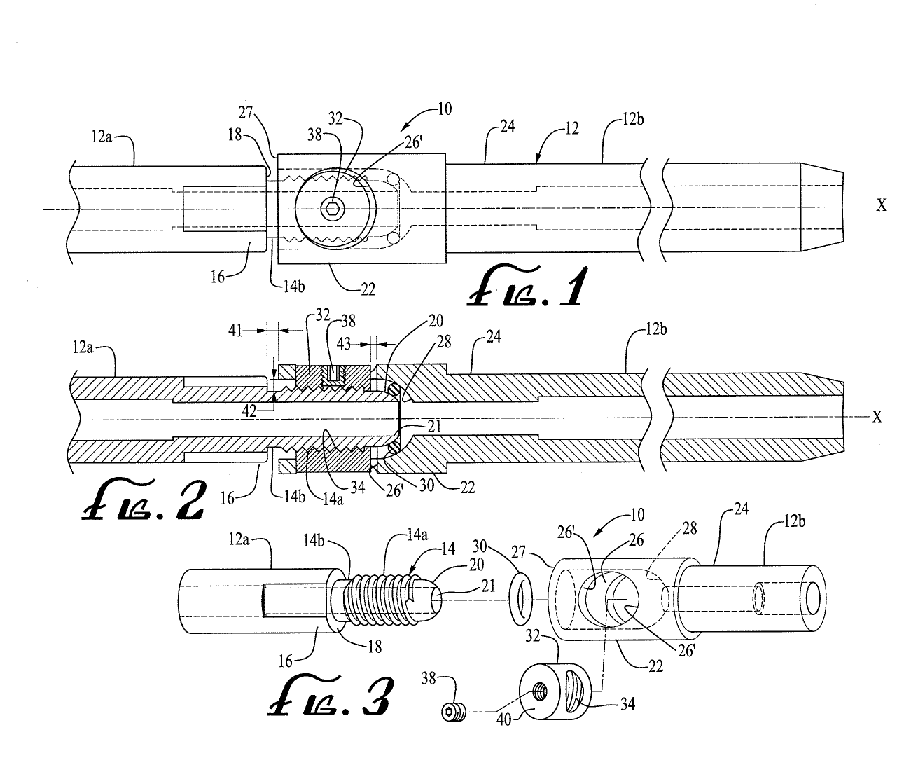

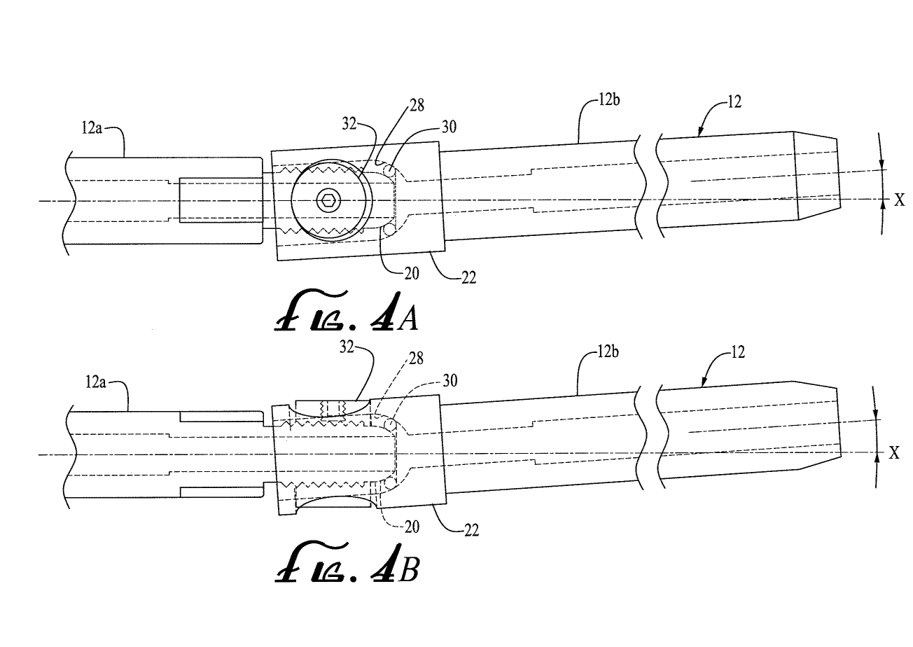

Referring now in detail to the drawings, a first embodiment of the flexural joint 10 of the present invention is illustrated in FIGS. 1-4. As shown therein, joint 10 is disposed between and secured to a first rigid conduit portion 12a and a second rigid conduit portion 12b so as to define a fluid-tight conduit 12 in which the conduit portions 12a and 12b can be flexed relative to each other so as to obviate wear and leakage problems that otherwise might result if the connections for the extended ends of a rigid conduit were out of axial alignment. As used herein, the term “flex” or “flexed” means relative rotational and/or pivotal movement of one portion of a conduit with respect to a second portion thereof.

Joint 10 comprises a hollow nipple 14 preferably integrally formed with and projecting from one end 16 of the first conduit portion 12a. The nipple 14 can be of a reduced diameter so as to define a shoulder 18 between conduit portion 12a and the nipple 14. The nipple 14 preferably defines a threaded portion 14a and a constant radius portion 14b between the shoulder 18 and the threaded nipple portion. The extended forward end of the nipple preferably is radiused and defines an annular curvilinear sealing surface 20 disposed about and adjacent to a conduit opening 21.

A hollow knuckle housing 22 projects axially from and preferably is integrally formed with an end 24 of the second conduit portion 12b, such that fluid can pass axially therethrough. The knuckle housing 22 also defines an opening 26 extending transversely therethrough adjacent to the open extended end 27 thereof. The second conduit portion 12b preferably defines an annular interior shoulder 28 at the base of the knuckle housing 22 for supporting an annular flexible sealing member 30 therein, preferably an o-ring, as illustrated in FIG. 3.

A cylindrical knuckle 32 having a threaded aperture 34 extending therethrough is disposed in the transverse opening 26 of the knuckle housing such that the threaded aperture 34 in the knuckle in axial alignment with the central axis of the conduit section 12b. The nipple 14 projecting from the first conduit portion 12a is extended into the knuckle housing 22 and aperture 34 in the knuckle and rotated so as to threadably engage the knuckle 32 and extend therethrough within the knuckle housing 22 such that the annular sealing surface 20 on the extended end of the nipple engages the sealing member 30 in the knuckle housing and presses the sealing member against shoulder 28, forming a fluid-tight seal between the two conduit portions 12a and 12b.

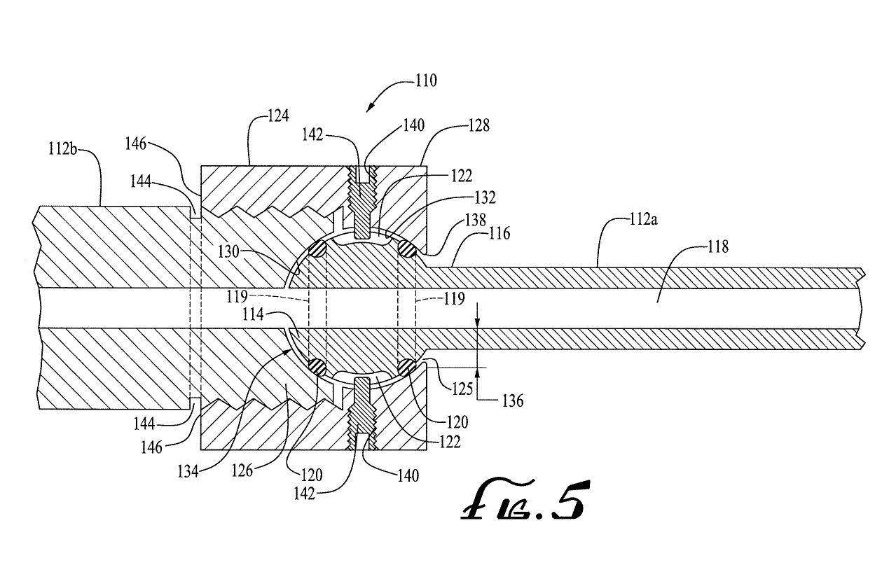

To provide the desired seal between the interior shoulder 28 in the knuckle housing and the tapered sealing surface 20 at the end of nipple 14, a spacer (not shown) of a predetermined desired thickness can be disposed between the extended end 27 of the knuckle housing and the shoulder 18 extending about the first conduit portion 12a as the nipple 14 is threaded onto the knuckle 32. Once the nipple 14 projecting from the first conduit portion 12a is threaded onto and through the knuckle 32 such that the extended end 27 of the knuckle housing 22 and shoulder 18 on the first conduit portion abut the opposed sides of the spacer, the desired pressure against seal 30 is attained as well as the predetermined spacing between the two conduit portions so as to allow for the desired flexure therebetween as will be explained. The knuckle 32 then is locked in place on the threaded nipple so as to prevent further relative rotation therebetween. This can be achieved mechanically using, for example, a set screw 38 extending through one end 40 of the knuckle and bearing against the side of the threaded nipple or chemically using, for example, cold soldering. Cold soldering is preferred for smaller applications due to the limited area available for the head of a set screw and the likelihood of stripping the head during the tightening of the set screw against the side of the nipple. Once the knuckle is secured to the nipple at the desired location, the two conduit sections are secured together in an airtight fitment and can be flexed with respect to one another in a 360 degree arc about the central axis (X) of the fluid flow conduit 12 as illustrated in FIGS. 4A and 4B.

The extent of the flex in conduit 12 provided by joint 10 can be determined in part by the spacing 41 between the shoulder 18 at the end of the first conduit portion 12a and the end 27 of the adjacent knuckle housing, in part by the radial spacing 42 between the outer surface constant radius portion 14b of nipple 14 and the interior surface about the open end 27 of the knuckle housing and, in part by the relative sizing of the diameters of the cylindrical knuckle 32 and the transverse opening 26 in the knuckle housing 22 through which the knuckle extends. That relative sizing defines a spacing 43 between the knuckle and knuckle housing. The extent of the flex between the two portions 12a and 12b of the conduit 12 about its central axis (X) can be limited by spacing 41 if the shoulder 18 and knuckle housing end 27 are sufficiently close together that they can abut one another as the conduit is flexed, and thus prevent any further relative flexing. By not reducing the diameter of nipple 14 relative to the outer diameter of the first conduit portion 12a, shoulder 18 would be eliminated which would avoid the aforesaid abutment as a flex limiting factor. However, the axial length of spacing 41 also provides a measure of the tightness of the seal against sealing member 30 in the knuckle housing. Thus, shoulder 18 provides a convenient means for determining the desired spacing 41 using a spacer as described in the preceding paragraph. Accordingly, it is believed preferable, but not always necessary, to retain the shoulder 18 as previously described and position the shoulder such that it is disposed a sufficient axial distance from the knuckle housing end 27 so as to avoid any abutment therebetween during flexing unless the additional flex allowed by so positioning the shoulder is not needed.

Spacing 43 limits the relative flex between conduit portions 12a and 12b if, during flexing, the aperture wall 26′ extending about the aperture 26 in the knuckle housing abuts the side of the knuckle prior to the interior surface about the open end 27 of the knuckle housing abutting the nipple 14. The determination of spacings 42 and 43 will depend on the sizes of the conduits and the amount of flex needed. By coordinating spacings 42 and 43, the conduit portions 12a and 12b are free to flex a predetermined amount in a 360 degree arc about the central conduit axis (X).

By way of example only, in a rotary union assembly application for an automatic tire inflation system such as those disclosed in U.S. Pat. No. 8,028,732, the conduit(s) extending between the interior of the axle spindle and the rotary union housing could be replaced with conduit portions 12a and 12b configured as described above so as to be secured together in a fluid-tight flexural joint by joint 10 of the present invention. Variations in the size of the components and the relative spacing and other modifications may yield varying degrees of flexures. The relative dimensions of the components and spacings will vary depending on the amount of flex desired and the size of the conduit. The teachings of U.S. Pat. No. 8,028,732 are incorporated by reference as though fully disclosed herein,

In such rotary union applications, the joint 10 allows for the conduit between the axial spindle and the rotary union to be made entirely of a rigid material, e.g., stainless steel, to prevent wear and cold flow during use while accommodating misalignment between the hub cap, on which the rotary union assembly would be mounted (and into which the first conduit portion 12a would extend) and the axle spindle (through which the second conduit section portion 12b would extend), thereby reducing stress on the conduit and preventing leakage through misaligned seals.

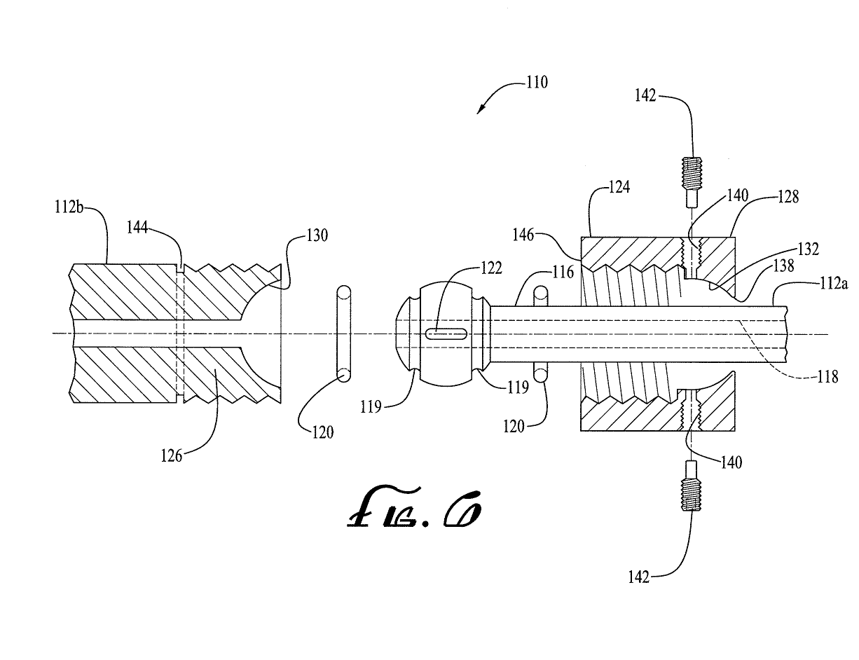

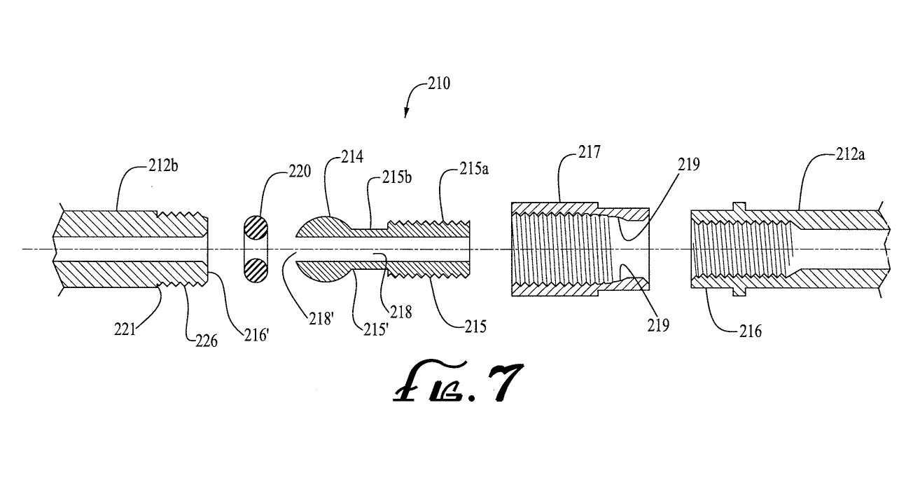

A second embodiment of the flexural joint of the present invention is illustrated in FIGS. 5 and 6. As seen therein, the flexural joint 110 is disposed between and secured to a first rigid conduit portion 112a and a second rigid conduit portion 112b so as to define a fluid-tight conduit 112 in which the conduit portions 112a and 112b can again be flexed relative to each other so as to obviate the previously discussed wear and leakage problems that otherwise can result when the connections with the extended ends of the conduit are misaligned.

Flexural joint 110 comprises a knuckle 114 that preferably is integrally formed with and projects from one end 116 of the first conduit portion 112a. The knuckle 114 defines a generally spherical outer surface and a channel 118 extending therethrough that is axially aligned with and in fluid communication with the first conduit portion 112a. The knuckle 114 also defines a pair of axially spaced parallel annular grooves 119 therein for carrying a pair of flexible sealing members 120, preferably o-rings, and a pair of opposed axially extending slots 122 between grooves 119, the purpose for which will be hereinafter described.

A cap 124 defining an aperture 125 in an extended end thereof is preferably threadably engaged with an end portion 126 of the second conduit portion 112b so as to project axially therefrom. The cap 124 is configured so as to cooperate with the end portion 126 to define a knuckle housing 128 extending about the generally spherical knuckle 114 such that the first conduit portion projects axially from the knuckle housing 128 through the aperture 125 therein with the knuckle retained within the knuckle housing due to the relative sizing between the knuckle and the aperture 125 in the end of cap 124 as illustrated in FIG. 5. The end portion 126 of the second conduit portion 112b defines a curvilinear end surface 130 that cooperates with a curvilinear interior surface 132 on cap 124 such that when the cap threadably engages the conduit end portion 126, surfaces 130 and 132 collectively define a generally spherical seat or sealing surface 134 disposed about and uniformly spaced from the outer curvilinear surface of the knuckle 114 with the sealing members 120 in grooves 119 forming a fluid-tight seal therebetween.

With the knuckle 114 held within the knuckle housing 128 by the threaded engagement of cap 124 with the end portion 126 of the second conduit portion 112b, the first and second conduit portions are physically secured together in an airtight fitment and can flexed with respect to one another as a result of the sealed ball and socket-type joint created by the knuckle 114, knuckle housing 128 and sealing members 120. The relative movement of the first and second conduit portions is limited by the spacing 136 between the end of conduit portion 112a adjacent knuckle 114 and the proximate annular edge 138 of the cap 124 adjacent to the outer end of the aperture 125 in the cap 124 as seen in FIG. 5. By increasing the spacing 136, the amount of flex between the two conduit portions can be increased.

In many applications, including rotary union applications, it is desirable to prevent relative rotation between the two conduit portions 112a and 112b. Accordingly, the two opposed axially extending slots 122 can be provided in the knuckle 114 and a pair of opposed threaded recesses 140 can be provided in cap 124 so as to receive set screws 142 that when fully screwed into recesses 140, project into slots 122 and bear against the bottom surfaces of the slots, preventing relative rotation of the knuckle and the knuckle housing and thus any relative rotation of conduit portions 112a and 112b.

To obtain the desired tightness of the cap 124 on conduit portion 112b and thus the desired sealing pressure on the sealing members 120, an annular groove 144 can be provided in the end portion of conduit portion 112b adjacent to the threads thereon whereby a spacer (not shown) of desired thickness can be inserted into the groove and the threaded cap 124 tightened until the end 146 thereof abuts the spacer. The spacer is of a predetermined thickness such that upon removal of the spacer, the desired sealing tightness of the knuckle housing about sealing members 120 is attained. For different conduit applications, differently sized spacers could be employed.

Joint 110 provides improved balance for the seal as compared to joint 10 for use in applications where greater flex is needed, particularly in high pressure applications. During use, it is important that an annular sealing member, such as an o-ring, when subjected to imbalanced forces, does not “run out of stroke” so that when the sealing member is tightly squeezed on one side, the other side is not subjected to so little pressure that is not flexed at all or is flexed to such a slight extent that the seal is lost. In higher flow pressure applications, the problem becomes more acute. In joint 10 of the prior embodiment, the pivot point is at the knuckle 32 and as the sealing member 30 is positioned further from the pivot point than are the sealing members 120 in joint 110, as the point of rotation during flex is located at the center of the knuckle. As a result, in high pressure applications requiring a greater degree of flex, the sealing member in joint 10 may run out of stroke more quickly than the sealing members in joint 110. Joint 10, however, has been found to provide excellent results in applications, such as rotary union applications, where significant conduit flex is not required, and the available radial space needed to accommodate a spherical knuckle 114 and the surrounding rotary housing 128 of joint 110 may not be available.

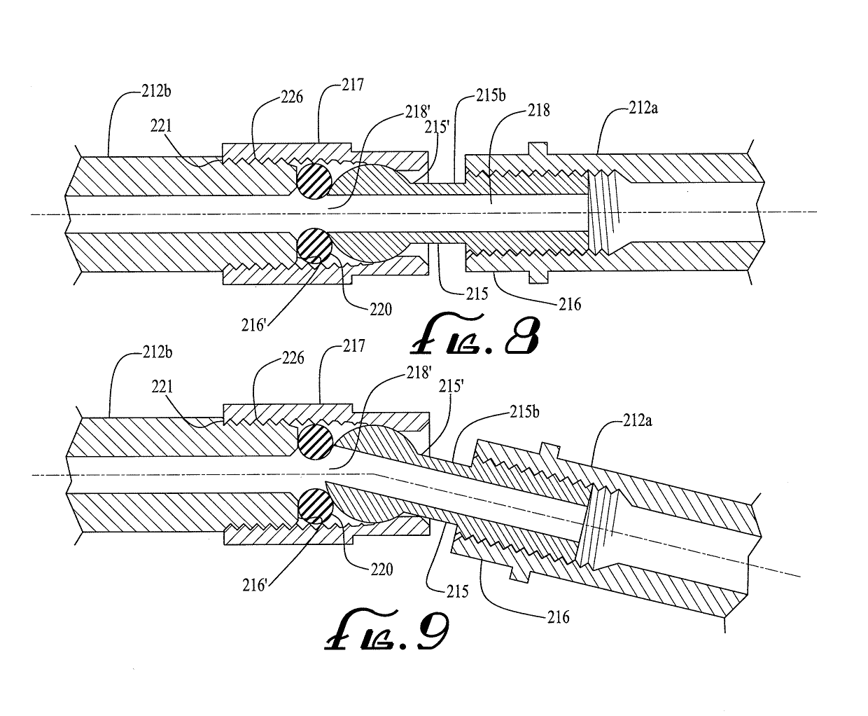

A modification of the second embodiment of the flexural joint of the present invention is illustrated in FIGS. 7-9. As seen therein, the flexural joint 210 is disposed between and secured to a first rigid conduit portion 212a and a second rigid conduit portion 212b so as to define a fluid-tight conduit 212 in which the conduit portions 212a and 212b can again be flexed relative to each other (see FIG. 9).

Flexural joint 210 comprises a knuckle 214 that is preferably integrally formed with and projects from one end 215′ of a conduit extension 215. The knuckle 214 preferably defines a generally spherical outer surface and with the conduit extension 215, defines a channel 218 extending axially through the knuckle and conduit extension. The conduit extension 215 also defines a threaded end portion 215a and a necked-down portion 215b disposed between the threaded portion 215a and the spherically-shaped knuckle 214 as seen, for example, in FIG. 7. A knuckle housing 217 extends over and about the conduit extension 215 and the knuckle 214 thereon and threadably engages an end portion 226 of conduit portion 212b. A flexible sealing member 220, preferably an o-ring, is disposed between the end face 216′ of the conduit portion 212b and the knuckle 214 about the opening 218′ in the knuckle to channel 218. Upon a tightening the knuckle housing 217 about the threaded end portion 226 of conduit 212b with the tubular extension 215 extending through the housing 217, the sealing member 220 is pressed against and between the end face 216′ of the conduit portion of 212b and the knuckle 214 on the conduit extension with an annular portion 214′ of the knuckle 214 being pressed against an interior annular seat 219 formed within the knuckle housing 224.

The interior annular seat 219 in the knuckle housing 217 preferably is configured so as to mate with the rounded exterior surface of the knuckle 214 so as to operatively connect the fluid conduit portion 212b in a fluid-tight communication with the conduit extension 215 and allow for rotation and pivotal movement of the conduit extension with respect to conduit portion 212b. Again, the terms flex, flexing and flexural are used herein to describe such rotational and/or pivotal movement.

A stop is defined by an annular shoulder 221 on conduit portion 212b adjacent the threaded end portion 226 thereof to limit the extent to which the knuckle housing 217 can be tightened about end portion 226 to facilitate assembly and provide the desired pressure exerted by the end face 216′ of conduit portion 212b and the knuckle 214 on the annular sealing member 220 to provide the desired fluid-tight seal therebetween while allowing for such pivotal movement, i.e., flexing.

To complete joint 210, the threaded end portion 215a of the conduit extension 215 projects through the knuckle housing 217 and threadably engages an extended end 216 of the first conduit portion 212a thereby operatively connecting conduit portion 212b with conduit portion 212a such that the necked-down portion 215b of the conduit extension 215 cooperates with the spherical surface of the knuckle 214 and the mating annular seat 219 in the knuckle housing 217 so as to allow relative flexing of conduit portions 212a and 212b as illustrated in FIG. 9 while maintaining a fluid-tight connection therebetween.

Joint 210 retains the balance in high flex applications of the previously described joint 110, provides smooth swiveling of the two conduit portions 212a and 212b, is easy to assemble and eliminates one of the sealing members utilized in joint 110. Joint 210 is also highly suitable for applications where minimal space is available. While joint 210 allows relative rotation of conduit portions 212a and 212b, if desired, opposed slots similar to slots 122 in the knuckle 114 of joint 110 can be provided in knuckle 214 of joint 210 for use in cooperation with a pair of set screws and threaded recesses like screws 142 and recesses 140 in joint 110 to prevent such relative rotation.

Although the present invention has been described by way of exemplary embodiments, it should be understood that many changes and substitutions may be made by those skilled in the art without departing from the spirit and the scope of the present invention. Insofar as these changes and substitutions are within the purview of the appended claims, they are to be considered as part of the present invention.

What is claimed is:

1. A fluid-tight flexural joint for enabling a first portion of a rigid fluid flow conduit to flex with respect to a second portion thereof to accommodate off-axis conduit connections, said joint comprising: a hollow nipple configured to project axially from one end of a first conduit portion; a knuckle housing configured to project axially from one end of a second conduit portion; a cylindrical knuckle having a transverse opening extending therethrough, said knuckle being disposed in said knuckle housing such that said transverse opening in said knuckle is in axial alignment with said first and second conduit portions, said nipple on said first conduit portion projecting through the transverse opening in said knuckle and engaging said knuckle so as to be moveable with the knuckle relative to said knuckle housing while defining a continuous fluid passageway extending through said first and second conduit portions, said nipple and said knuckle; an annular flexible sealing member disposed between a portion of said knuckle housing and a portion of said nipple forming an airtight seal between said first and second conduit portions; and means for locking said nipple to the knuckle so as to prevent relative rotation therebetween within the housing whereby said first and second conduit portions are coupled together in a flexible fluid-tight sealing engagement.

2. The fluid-tight flexural joint of claim 1 wherein said nipple threadably engages said knuckle about said transverse opening in said knuckle.

3. The fluid-tight flexural joint of claim 1 wherein said means comprises a set screw extending through said knuckle and against said nipple.

4. The fluid-tight flexural joint of claim 1 wherein said nipple is cold soldered to said knuckle to effect a locking securement of said nipple to said knuckle.

5. The fluid-tight flexural joint of claim 1 wherein said sealing member is an o-ring.

6. A fluid-tight flexural joint for enabling a first portion of a rigid fluid flow conduit to flex with respect to a second portion thereof to accommodate off-axis conduit connections, said joint comprising: a generally spherical knuckle projecting axially from one end of a first conduit portion, said knuckle defining a fluid flow channel extending therethrough in axial alignment and fluid communication with the first conduit portion; a knuckle housing threadably engaging an end portion of a second conduit portion, said housing being in fluid communication with the second conduit portion and disposed about and in sealing engagement with said knuckle so as to define a continuous fluid passageway extending through said first and second conduit portions and said knuckle whereby the first and second conduit portions are coupled together in a flexible fluid-tight sealing engagement.

7. The fluid-tight flexural joint of claim 6 including means for preventing relative rotation between said knuckle and said knuckle housing.

8. The fluid-tight flexural joint of claim 6 including a pair of axially spaced flexible sealing members disposed about said knuckle, one of said sealing members forming a fluid-tight seal between said knuckle and said knuckle housing and a second of said sealing members forming a fluid-tight seal between said knuckle and said end portion of said second conduit portion.

9. The fluid-tight flexural joint of claim 6 including an annular sealing member disposed within said knuckle housing and forming a fluid-tight seal between said knuckle and said end portion of said second conduit portion.

10. A fluid-tight flexural joint for enabling a first portion of a rigid fluid flow conduit to flex with respect to a second portion thereof to accommodate off-axis conduit connections, said joint comprising: a conduit extension defining first and second end portions, said first end portion being configured for engagement with a first conduit portion; a generally spherical knuckle projecting axially from said second end portion of said conduit extension, said knuckle and said conduit extension defining a fluid flow channel extending axially therethrough; a knuckle housing threadably engaging an end portion of a second conduit portion, said housing being in fluid communication with the second conduit portion and disposed about and in sealing engagement with said knuckle so as to define a continuous fluid passageway extending through said first and second conduit portions, said knuckle and said conduit extension while allowing for rotational and pivotal movement of said conduit extension with respect to said second conduit portion whereby said first and second conduit portions are coupled together in a flexible fluid-tight sealing engagement.

11. The fluid-tight flexural joint of claim 10 including means for preventing relative rotation between said knuckle and said knuckle housing.

12. The fluid-tight flexural joint of claim 10 including an annular flexible sealing member disposed within said knuckle housing between said knuckle housing and an end portion of said second conduit portion.

13. The fluid-tight flexural joint of claim 11 including an annular flexible sealing member disposed within said knuckle housing between said knuckle housing and an end portion of said second conduit portion.
